(19) United States
(12) Patent Application Publication
(10) Pub. No.: US 2006/0229058 A1
(43) Pub. Date: Oct. 12, 2006

(54) Real-time person-to-person communication using geospatial addressing

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, Pismo Beach, CA (US)

(21) Appl. No.: 11/425,990

(22) Filed: Jun. 22, 2006

Related U.S. Application Data
(63) Continuation-in-part of application No. 11/344,612, filed on Jan. 31, 2006.
(60) Provisional application No. 60/731,180, filed on Oct. 29, 2005.

(51) Int. Cl. H04M 11/04

(52) U.S. Cl. 455/404.2

(57) ABSTRACT

Real-time location-based messaging methods and systems enable users of portable computing devices to communicate with other users of portable computing devices based upon the current geographic location of the one or more users. A user can select or define a geographic coordinate(s) in the physical world and a proximity/area around the geographic coordinate(s) as a means of identifying one or more users of portable computing devices to whom the first user will communicate with. The user can select the geographic coordinate(s) and/or define a proximity or area around the geographic coordinate(s) using a geospatial dataset and an interactive graphical user interface for navigating the geospatial dataset and selecting coordinates and/or proximities and/or area within the real physical world. A user can select geographic coordinate(s) and/or define a proximity/area in the real physical world as part of a person-to-person messaging or person-to-person communication process using a geospatial navigation software tool.

This application claims the benefit of U.S. Provisional Application No. 60/731,180, filed Oct. 29, 2005, which is incorporated in its entirety herein by reference.

This application is a continuation-in-part of U.S. patent application Ser. No. 11/344,612, filed Jan. 31, 2006 and entitled “POINTING INTERFACE FOR PERSON-TO-PERSON INFORMATION EXCHANGE,” which is incorporated in its entirety herein by reference.

The present invention is also related to the following co-pending U.S. Patent Applications, all of which are incorporated in their entirety herein by reference:

U.S. patent application Ser. No. 11/383,197, of Rosenberg, filed on May 12, 2006, and entitled “LOCATION-BASED DEMOGRAPHIC PROFILING SYSTEM AND METHOD OF USE”,

U.S. patent application Ser. No. 11/315,755, of Rosenberg, filed on Dec. 21, 2005, and entitled “METHOD AND APPARATUS FOR ACCESSING SPATIALLY ASSOCIATED INFORMATION”; and

U.S. patent application Ser. No. 11/344,701, of Rosenberg, filed on Jan. 31, 2006, and entitled “TRIANGULATION METHOD AND APPARATUS FOR TARGETING AND ACCESSING SPATIALLY ASSOCIATED INFORMATION”.

### BACKGROUND

1. Field of Invention

Embodiments exemplarily described herein relate generally to storage and access of information based upon physical geographic locations. Embodiments exemplarily described herein also relate generally to person-to-person communication enabled by portable devices such as cellular phones, personal digital assistants, and other similar mobile electronic devices with communication capabilities. Embodiments exemplarily described herein also relate generally to mobile social networking applications that track the location of a plurality of users of mobile electronic devices upon one or more servers that are accessible by one or more of the plurality of users over a communication link. More specifically, embodiments exemplarily described herein relate to methods and systems that facilitate a user to send messages (e.g., an email, text message, voice message, video message, instant message, or other similar messaging means) to other users and/or to initiate communication with other users (e.g., via real-time instant messaging, real-time phone conversations, real-time video-phone connection, real-time chat, or other similar real-time communication means).

2. Discussion of the Related Art

A number of systems have been developed for enabling users to access spatially associated information, meaning information that is associated with specific geographic locations in the physical world. An early implementation of such a system is described in the paper by Spohrer entitled INFORMATION IN PLACES and published in IBM Systems Journal, vol. 38, No. 4, 1999 (p. 602-628), which is hereby incorporated by reference. As implemented in the prior art, spatially associated information is created and associated to a particular location (or locations) during an authoring process, and then is accessed by a user of a portable computing system when that user travels to or near that particular geographic location in the physical world. Such methods allow historical information, educational material, virtual notes, advertisements, and other pre-planned information to be left at particular locations in physical space such that users who subsequently visit those locations in physical space may access the associated information. The systems generally operate by having users wield a portable computing device that is equipped with a spatial location sensor, the portable computing device accessing information as the user of the device carries it to new locations. Thus, the process of the prior art in one in which information is authored in advance and/or associated with particular locations in advance, and then is subsequently accessed by a user who carries his or her enabled portable computing device to the associated location. A plurality of users who travel to a particular location over a period of days or weeks or months or years, will gain access to the information that is associated with that location.

For example, U.S. Pat. No. 6,122,520 entitled SYSTEM AND METHOD FOR OBTAINING AND USING LOCATION SPECIFIC INFORMATION, and hereby incorporated by reference, describes a system that uses Navstar Global Positioning System (GPS) as the spatial location sensor, in combination with a distributed network, to access location related information based upon GPS coordinates that describe the current location of a portable computing device. In addition, U.S. Pat. No. 6,819,267 entitled SYSTEM AND METHOD FOR PROXIMITY BOOKMARKS USING GPS AND PERVASIVE COMPUTING, and hereby incorporated by reference, also describes a system for accessing location related information using GPS coordinates that describe the current location of a portable computing device. U.S. Patent Application Publication No. 2005/0032528 entitled GEOGRAPHICAL WEB BROWSER, METHODS, APPARATUS AND SYSTEMS, and hereby incorporated by reference, also describes a system for accessing location related information using GPS coordinates that describe the current location of a portable computing device. A significant problem with such systems is that a user may want to gain information about a location that they are not local to, but which is off in the viewable distance to that user. Another limitation with the aforementioned systems is that while they enable a user to associate a piece of information with a particular location in advance of other users traveling to that location and subsequently accessing the information, they do not enable real-time messaging between users based upon then current location of recipients. For example, a user may wish to send a real-time message to all users who are then currently within a certain proximity of a particular geographic location (for example, a high school football field). Accordingly, it would be beneficial if there existed a technology that facilitated real-time location-based messaging (i.e., messaging between users based upon then current location of recipients).

Mobile social networking systems are generally operated as managed services by application service providers (ASPs) and operate using several common characteristics. For example, users typically create unique personal profiles that include basic information including age, gender, user name, interests, profession, history, testimonials and information about their network. In some applications, users map their relationship with other members, either by inviting other members to join their network (e.g., Friendster and/or Linkedin), or by using software to scan existing relationships recorded in computer contact software (e.g., Spoke and/or Visible Path). Most commonly, these applications provide such functions as friend-finding, text-dating 2and community message aggregation. Friend-finder applications (e.g., Dodgeball) can identify the location of the user and the friend of a user and alert the user when the friend is within a certain proximity. Such applications may also consult the relationship map and identify “friends of friends” who have announced they are within a certain range of the user's vicinity. Text-dating applications (e.g., MobiVibe) allow users to connect with new friends who meet age and gender criteria, enabling users to communicate, e.g., to exchange text messages. Community message aggregators (e.g., Upoc) distribute messages from one member to all members within a specific community. A system disclosed in U.S. Patent Application Publication No. 2005/0177614, which is hereby incorporated by reference, enables like-minded mobile device users to meet one another, on a permission basis, based upon one or more factors such as: each user's reciprocal networking objective, the nature of the industry in which the user works, the user's level within the management hierarchy of his or her company, any specialty function the individual may possess, and so on.

A problem with current mobile social networking systems such as those mentioned above is that they do not allow a user to send real-time messages and/or a real-time communication request with other users who are within a certain proximity of a particular target geographic location as determined by a comparison of spatial coordinates for each of the other users and the specified target geographic coordinates. Accordingly, it would be beneficial if there existed a technology that enables a user to specify a target geographic location for a real-time message and/or real-time communication request.

### SUMMARY

Several embodiments exemplarily described herein advantageously address the needs above as well as other needs by providing real-time person-to-person communication using geo-spatial addressing.

One embodiment exemplarily described herein can be characterized as a location-based communication method that includes steps of receiving location information that identifies a current geospatial location of a mobile computing device of each of a plurality of users; receiving a geo-spatial address from a device of a calling user; determining whether the current geospatial location of the mobile computing device satisfies a predetermined relationship with the geo-spatial address; identifying a unique identifier associated with the mobile computing device having a current geospatial location determined to satisfy the predetermined relationship with the geo-spatial address; and routing a real-time communication from the caller to the mobile computing device having a current geospatial location determined to satisfy the predetermined relationship with the geo-spatial address via the identified unique identifier.

Another embodiment exemplarily described herein can be characterized as a location-based communication system that includes a server containing circuitry adapted to: receive location information that identifies a current geospatial location of a mobile computing device of each of a plurality of users; receive a geo-spatial address from a device of a calling user; determine whether the current geospatial location of the mobile computing device satisfies a predetermined relationship with the geo-spatial address; identify a unique identifier associated with the mobile computing device having a current geospatial location determined to satisfy the predetermined relationship with the geo-spatial address; and route a real-time communication from the caller to the mobile computing device having a current spatial location determined to satisfy the predetermined relationship with the geo-spatial address via the identified unique identifier.

Another embodiment exemplarily described herein can be characterized as a location-based communication method that includes generating a geo-spatial address; addressing a real-time communication with the geo-spatial address; and transmitting the real-time communication addressed with the geo-spatial address to a server, wherein the server is adapted to route the real-time communication to a mobile computing device that has a current geospatial location satisfying a predetermined relationship with the geo-spatial address.

Another embodiment exemplarily described herein can be characterized as a location-based communication system that includes a computing device containing circuitry adapted to: generate a geo-spatial address; and address a real-time communication with the geo-spatial address. The computing device further includes a transmitter adapted to transmit the real-time communication to a server. The server is adapted to route the real-time communication to a plurality of mobile computing devices that have a current geospatial location satisfying a predetermined relationship with the geo-spatial address.

### BRIEF DESCRIPTION OF THE DRAWINGS

The above and other aspects, features and advantages of several embodiments exemplarily described herein will be more apparent from the following more particular description thereof, presented in conjunction with the following drawings.

FIG. 1 illustrates a schematic representation of one embodiment of a real-time location-based communication system;

FIG. 2 illustrates one embodiment of a portable computing device shown in FIG. 1;

FIGS. 3 and 4 illustrate exemplary user interface screens of a geo-spatial navigation and imaging software application; and

FIGS. 5-7 illustrate an exemplary user interface screens of an enhanced geo-spatial navigation and imaging software application implemented in conjunction with various embodiments of the real-time location based messaging system.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments exemplarily described herein. Also, common but well-understood elements that are useful or necessary in a commercially feasible embodiment are often not depicted in order to facilitate a less obstructed view of these various embodiments exemplarily described herein.

### DETAILED DESCRIPTION

The following description is not to be taken in a limiting sense, but is made merely for the purpose of describing the general principles of exemplary embodiments. The scope of the invention should be determined with reference to the claims.

Generally, embodiments described herein provide real-time location-based messaging methods and systems adapted to send real-time messages and/or for initiating real-time communication via a communication request from one person to one or more other persons based upon the then current spatial locations of the one or more other persons. As used herein, a person who sends a real-time message and/or a real-time communication request with one or more other people is referred to as a “caller” or a “calling user.” As also used herein, a person who receives a real-time message and/or receives a real-time communication request is referred to herein as a “recipient” or a “receiving user.” Thus, according to the phrases defined herein, methods and systems described herein enable a caller to send a real-time message to and/or a real-time communication request with one or more recipients based upon the then current spatial locations of the one or more recipients. More specifically, methods and systems described herein enable a caller to specify a particular geographic location or area by spatial coordinates and thereby send a real-time message to and/or a real-time communication request with one or more recipients who are then currently located at or near the specified geographic location or area. That is, embodiments described herein enable a caller to send a message to and/or initiate communication with recipients, not by providing a phone number, email address, user ID, or other personal identifier of the recipients, but instead by specifying a particular geographic location and thereby have the message sent to one or more recipients who are located at or near that geographic location at the time when the message was sent. As used herein, the coordinates of a particular geographic location and/or a particular geographic area to which a real-time message or communication request is sent, is referred to herein as a “geo-spatial address.”

As used herein, the phrase “real-time” means that the time when a caller sends a message is substantially the same as the time when the message is received by a recipient. Obviously, there is some time-delay between these two events by virtue of the fact that time is required for a messages to be processes, transmitted, decoded, and received by a recipient. Accordingly, a real-time message has a short enough time delay that the user who sends the message thinks of it conceptually as nearly instantaneous. For example, when a person in today's world makes a phone call, he or she thinks of it as real-time even though there is a short time delay involved. Similarly, when a person in today's world sends an instant message or communicates in a chat room, he or she thinks of it as real-time even though there is a short time delay involved. It is in this context that the phrase “real-time” is used.

Thus, embodiments exemplarily described herein provide methods and systems by which a caller may specify a particular geo-spatial address by indicating particular spatial coordinate(s) and/ or proximity parameters and/or area parameters and thereby send a real-time message to and/or a real-time communication request with one or more recipients who are then currently located at or near the specified location or area. To enable such functionality, a server is provided for associating particular users (or the devices of users) with particular spatial coordinates such that a message sent to a particular addressed location or area can be routed to the correct user or users based upon each of their then current geographic locations. The server may be a single server, a network of servers, or a plurality of independently operated servers such that the server or servers provide associations between specific users (by virtue of a unique ID for each) and the current spatial location of those users in the physical world (as tracked by one or more sensors). As used herein, the term “spatial messaging server” is used to describe such a server that performs this function whether it be a single server, a network of servers, or a plurality of independently operated servers.

Also as defined herein, a “spatial location” is a discrete location, usually defined by spatial coordinates, in the real physical world. As also defined herein, a “spatial area” is a range of locations that fall within certain boundaries or borders within the real physical would and is usually defined by a set of spatial coordinates and/or as one or more spatial coordinates combined with a proximity, area, or volume. For example, a circular area of radius r may be defined around a particular spatial coordinate as a means of defining a spatial area within the context. In common embodiments, spatial location and/or spatial areas are defined using a global coordinate system of latitude values, longitude values, and optionally elevation values.

In addition, spatial locations and/or spatial areas may be defined and or associated with specific directional values. In this way, a spatial location and/or spatial area may also have directionality associated with it. This enables certain unique messaging features, wherein a caller can send a real-time message to and/or a real-time communication request with all users who are at or near a particular area or location and who are facing and/or moving in a particular direction (or within a particular range of directions). Such features are particularly useful, for example, in addressing a message to all people who are walking through a particular intersection in a substantially north bound direction, while not addressing the message to those people walking in other directions. Thus, as defined herein a geo-spatial address may also include one or more directional values that are used define a required facing direction and/or required direction of motion of users at or near the specified location or area.

Although latitude, longitude, and, optionally, altitude coordinates are most commonly used, other coordinate systems and/or locative conventions may be used to achieve the functionality.

The spatial messaging server includes a digital memory for associating particular users with the particular spatial locations within the real physical world at which those users are located at the present moment in time. This digital memory is generally referred to as a tracking database. Unique user identifiers are also stored in a digital memory accessible to the spatial messaging server, the unique user identifiers including, for example, one or more unique user identifiers for each user such as that user's name, email address, messaging alias, phone number, and/or other unique number or code.

According to embodiments exemplarily described herein, one or more portable computing devices may be provided with wireless communication capabilities and spatial position tracking capabilities. The portable computing devices enable one or more users of the portable computing devices to receive real-time geo-spatially addressed messages and/or real-time geo-spatially addressed communication calls from callers. Accordingly, users may act as callers from one of the portable computing devices or from a stationary computing device such as a standard PC. The portable computing devices may include position sensing transducers for determining a current position of the portable computing device as the user of that device moves about the real physical world. Stationary devices used in conjunction with the embodiments described herein may store in memory a representation of their own geo-spatial location which remains fixed over time.

In common embodiments, the position sensing transducers that are included within and/or interfaced to the portable computing devices, are GPS transceivers for determining current latitude, longitude, and optionally elevation coordinates for the portable computing device as the user of that device moves about the real physical world. The portable computing device may also include orientation sensing transducers for determining a current orientation of the portable computing device (or a portion thereof) as the user moves about the real physical world. The orientation sensing transducer may include, for example a magnetometer and/or an accelerometer for detecting orientation values. In addition, the portable computing device (and/or the spatial messaging server) may be configured to store a time-history of positional values, the time-history of positional values being used by software upon the portable computing device and/or upon the spatial messaging server to determine a direction of motion and/or a rate of motion and/or a trajectory of motion of the portable computing device as manipulated by a user as he or she moves about the real physical world.

In some embodiments, the portable computing device may include an RFID scanner, a barcode scanner, and/or other means by which spatial coordinate information may be accessed with respect to the surroundings by reading and/or receiving locally encoded data. In addition, spatial location coordinate data may be provided by referencing a location service (e.g., a GSM location service provider) that provides a mobile device user's current location such as latitude and longitude. Such information may be used instead of or in combination with coordinate information derived from GPS transducers. In particular, such methods may be used in indoor situations wherein GPS transceivers may not be effective. Such information may also be used to supplement the spatial resolution provided by GPS transceivers. Embodiments will herein be described primarily with respect to GPS transceivers, for that is the most common current method by which a portable computing device may access locative coordinates within the real physical world. This should not limit the scope of the exemplarily described methods and systems to the use of GPS transceivers.

As described herein, the computing devices of users work in cooperation with the spatial messaging server to enable a caller to address a real-time message and/or real-time communication request (e.g., a call), generically referred to as a “real-time communication”, to a geo-spatial location or geospatial area in the physical world by specifying the physical coordinates of that location or area. By addressing a real-time message and/or real-time communication initiation in this way, the caller is enabled to send the real-time message and/or real-time communication request to one or more recipients who are currently located at or near the specified location or area. Thus, methods of addressing and routing real-time messages and/or real-time communication requests to users can be implemented by specifying a location in space (or area in space) rather than providing a unique user identifier for particular users. The spatial messaging server associates the geo-spatial address with the one or more specific users who are then currently at that location or area by keeping track of the current spatial location of a plurality of users of appropriately enabled portable computing devices within a tracking database.

The phrase “current spatial location” is used herein with the appreciation that there will generally be some amount time lag that causes the most current location stored in the tracking database for some or all users to reflect that user's location at a recent time in the past. It is therefore desirable to keep such time lags as small as possible within the practical limitations of the technology employed. It is also sometimes desirable to store a time-history of current geographic locations for the plurality of users, the time-history reflecting one or more previous but recent locations of each of the plurality of users. Furthermore, in some embodiments, the spatial messaging server is operative to predict a current location of a user based at least in part upon the stored time-history of previous locations of that user. Furthermore, in some embodiments, the spatial messaging server is operative to derive a speed of motion and/or a direction of motion of a user from the stored time-history of previous locations of that user. Furthermore, in some embodiments, the spatial messaging server is operative to predict a current location of a user based in part upon speed and/or direction of motion data received for that user over a communication link.

In many embodiments, the current spatial location of a user is tracked by monitoring the location of one or more portable computing devices on the person of that user. Thus, although this disclosure herein may refer to the tracking of the current spatial location of users, this is based upon assumption that in normal operation, each of the users has a portable computing device with him or her. Thus, it would be the same to refer alternatively to the tracking of the current spatial location of the portable computing devices being used by a user.

In several embodiments, the spatial messaging server contains spatial messaging circuitry adapted to perform the functions described herein. The term “circuitry” refers to any type of executable instructions that can be implemented, for example, as hardware, firmware, and/or software, which are all within the scope of the various teachings described. Such spatial messaging circuitry is also equivalently referred to herein as a “spatial messaging application”. To save space, the spatial messaging server, spatial messaging circuitry, and spatial messaging application will also be referred to herein as the “SM server,” “SM circuitry,” and the “SM application”, respectively. In addition to tracking the current geo-spatial location of a plurality of users of enabled portable computing devices, the SM application is also operative to store unique user identifier information for each of the plurality of users (and/or portable computing devices) being tracked. The unique user identifier information includes for example one or more of a phone number, email address, messaging alias, device address, URL, or other unique user ID that can be used to address that particular user and/or the portable computing device of that particular user over a communication network. For example, if the portable computing device is a phone and/or includes the functionality of a phone, the unique user identifier information likely includes the unique phone number for that phone.

Embodiments described herein may be implemented as a service that facilitates real-time person-to-person messaging and/or real-time person-to-person communication by and among computing device users. More specifically, embodiments described herein may be implemented as a service that facilitates real-time person-to-person messaging based upon geo-spatial addressing and/or person-to-person communication based upon geo-spatial addressing. As used herein, the phrase “geo-spatial addressing” refers to the process of a caller addressing his or her recipients, not by using a unique user-specific identifier for that individual (or device-specific identifier for the device of that individual), but by specifying a geo-spatial location and/or area with the understanding that one or more users who are currently at or near that location or area will be the recipients of the real-time message or real-time communication initiation request. Also, if no user is currently located at or near the specified geo-spatial location and/or area, the addressed real-time message and/or real-time communication initiation may not be received by any user. Thus, geo-spatial addressing is location specific—not user or device specific, and is dependent upon the current location of user at the time when the geo-spatially addressed message and/or communication initiation request was made. Such a service as described in this paragraph is referred to herein as a “spatial messaging service” or simply an “SM service”.

In some embodiments, users employ a Web browser (e.g., on a computer, or a portable computing device itself) to register online for the managed spatial messaging service that is provided by a system operator who administers the system and manages user tracking and geo-spatial addressing. In particular, the system operator runs at least one SM server that tracks the locations of a plurality of active portable computing device users (or devices). The server also maintains unique identifying information for each of the tracked portable computing device users (or devices). In some embodiments, the SM server interfaces to a telecommunications network through a gateway, such as a message gateway.

Thus, embodiments described herein employ a plurality of portable computing devices, each equipped with a positioning system such as a GPS transducer interfaced with a Navistar Global Positioning System (GPS) and each having wireless access to SM server running an SM application. Communication between each portable computing device and the SM server is generally enabled through a wireless transceiver connected to and/or integrated within each of the plurality of portable computing devices. The GPS transducer and/or other position and/or orientation transducers associated with each portable computing device is operative to generate a coordinate that relates to the then current position (and optionally orientation) of that portable computing device, the coordinate entry and/or a representation thereof is communicated over the wireless communication link to the SM server running the SM application along with identifying information that indicates from which portable computing device (and/or which user) the coordinate entry was received. In this way, the SM server running the SM application receives coordinate information representing the then current location (and optionally orientation) of each of a plurality of user's using an enabled portable computing device. In some embodiments, each portable computing device has a unique ID associated with it such that when coordinate data is transmitted to the SM server it is sent along with the unique ID such that the SM server can track by means of the unique ID which portable computing device among the plurality of portable computing devices having access to the SM server the coordinate data is associated with. In some embodiments, each user of a portable computing device has a unique ID associated with that user such that when coordinate data is transmitted to the SM server it is sent along with the unique ID such that the SM server can track by means of the unique ID which user among the plurality of users who are members of the SM server system the coordinate data is associated with.

By employing the embodiments described herein, the geo-spatial addressing method enables a first user of a computing device to send a real-time message or initiate real-time communication to one or more other users by addressing the message and/or communication request to a particular spatial location and/or spatial area, wherein the one or more other users use appropriately enabled portable computing devices as described above and currently residing at a location that is at or near the particular spatial location and/or spatial area. As defined herein, the phrase “at or near” means within a certain defined proximity of the geo-spatial location and/or area. As used herein the phrase “geo-spatial address” refers to a spatial location and/or spatial area in the physical world that is defined by one more geographic coordinates and is used for addressing a message as described above. A geo-spatial address may also include a spatial distance, boundary shape, area definition, and/or volume definition that is used in combination with the one or more geographic coordinates. For example, a basic embodiment of a geo-spatial address includes a geo-spatial coordinate and a proximity distance away from that coordinate. A common instantiation of such a geo-spatial address is represented as a GPS coordinate location in the physical world and a proximity distance specified in feet or meters away from that GPS coordinate location. For example, a geo-spatial address consistent with embodiments described herein is defined as a latitude/longitude pair equal to (37° 25′38.08″ N/122°04′49.98″W) and a proximity distance of 30 feet. This geo-spatial address is used to route an associated real-time message and/or real-time communication request to all enabled and active users who currently reside within 30 feet of the specified coordinates. As used herein, the phrase “users who currently reside” refers to users who are within the specified geo-spatial region at or approximately at the time when the real-time message and/or real-time communication request was sent.

In addition to the ability to address all users who currently reside within a certain geo-spatial region, the present invention may also be configured to enable the caller to specify one or more demographic qualifier tags that limit the routing of the message only to users who have personal data associated with them that meet those demographic qualifier tags. For example, a user may have personal data associated with him or her, for example stored upon the spatial messaging server, that indicates his or her gender, age, grade level, school affiliation, political affiliation, marital status, organizational affiliation, sports team partiality, musical group partiality, political candidate partiality, and/or other similar demographic quality or association. Using such information, the caller may be enabled to include one or more demographic qualifier tags with a geo-spatial message, thereby limiting the routing of the message not only to users who currently reside within the identified geospatial address area, but who also meet the demographic qualifier tag parameters. In this way, a user may, for example, send a message to all users of female gender who currently reside within a particular geospatial addressing area. Alternately, a user may send a message to all users who are affiliated with a particular school or who are fans of a particular sports team, who currently reside within the identified geospatial address area.

As an exemplary means of enablement of the above demographic qualifier tag features, co-pending U.S. patent application Ser. No. 11/383,197 entitled “Location-Based Demographic Profiling System and Method of Use” and filed by the present inventor, discloses methods and apparatus for maintaining a locative database for tracking a plurality of users, the database including demographic profile information for each of said plurality of users. This application is hereby incorporated herein by reference. As an additional and exemplary means of enablement of the above demographic qualifier tag features, co-pending U.S. patent application Ser. No. 11/383,195 entitled “Enhanced Storage and Retrieval of Spatially Associated Information” and filed by the present inventor, discloses method and apparatus for associating spatially linked information with demographic qualifier tags. This application is also incorporated herein by reference in its entirety.

The geo-spatial addressing method involves a number of steps. One step is referred to herein as a “background tracking step” because it is enacted continually in a background function, and involves tracking the location of a plurality of users of portable computing devices. In the background tracking step, each enabled and active portable computing device detects a current spatial positional coordinate from the spatial location sensor on board (or otherwise connected to) the portable computing device and reports a representation of the current spatial coordinate to the SM server. This step is repeatedly performed at a rapid rate such that the SM server receives repeatedly updated and substantially current data about the spatial location of the plurality of portable computing devices. The location information (e.g., spatial coordinates such as GPS coordinates of high resolution and accuracy), are stored in a tracking database by the SM server. The tracking database may also store a history of the location information for each of the plurality of portable computing devices. The tracking database may also include predictive location information for some or all of the plurality of portable computing devices, the predictive location information represents an anticipated location coordinate for a portable computing device as determined from current and/or historical location information and/or from velocity information for a portable computing device. Although there are many ways the tracking database may be maintained, the tracking database includes substantially current location information that represents the location of each of a plurality of portable computing devices based substantially upon positional data received by the SM server over a communication link.

A variety of techniques are disclosed below for reducing the amount of information that must be transmitted from each of the plurality of portable computing devices to the SM server during the background tracking step. These methods allow the SM server to maintain up-to-date spatial location information for each of the portable computing devices without requiring each portable computing device to spend spatial location data continually at all times. For example, in some such methods, each portable computing device only reports its current positional coordinates to the SM server if it is determined that the detected positional coordinates for that portable computing device has changed by more than some minimum threshold value since the last positional coordinate update was sent to the SM server. Such techniques are referred to herein as “smart locative reporting techniques,” for they intelligently reduce the amount of information that must be conveyed to the spatial messaging server by the mobile computing devices of the currently participating users.

The remaining steps of the geo-spatial addressing method are performed each time a user sends a real-time message and/or a real-time communication request using a geo-spatial address. These steps are referred to herein as geo-spatial addressing steps. In the first geo-spatial addressing step, a user addresses a real-time message and/or addresses a real-time communication request using a geo-spatial address. This may be performed by the user entering a spatial coordinate, such as a GPS coordinate, into an address line of a real-time messaging user interface and/or a real-time communication user interface. In addition the GPS coordinate the user may enter a proximity value defining the proximity to the GPS coordinate for which users will be targeted. Alternatively, the user may enter spatial area or volume values that define a bounded area or volume with respect to the GPS coordinate for which users will be targeted with the addressed message and/or communication request. Alternatively, the user may enter a set of GPS coordinates that define the boundaries of a spatial area within which users will be targeted with the message and/or communication request. In addition, the user may enter altitude values to further specify the geo-spatial location and/or area for addressing.

Because it is generally more cumbersome to enter a GPS coordinate than entering a phone number or email address, embodiments described herein provide user interface methods and systems to facilitate a user's efforts in defining a particular geo-spatial location and/or area to be used as the address for a message or communication request. As will be described in detail below, the user interface methods provide the caller with an interactive graphical environment for searching and finding desired geo-spatial locations within the physical world and selecting a location and/or area within the graphical environment for sending a geo-spatial message. In one embodiment, an existing software tool such as Google Earth is used as the graphical environment and is enhanced to support the geo-spatial messaging features disclosed herein by enabling users to interactively explore a graphical representation of the physical world and graphically select a geographic coordinate location for use as a geo-spatial messaging address. The selected coordinates are thereby automatically inserted into a selected real-time message and/or communication request. The addressing step of the messaging process need not be performed on a portable computing device. The caller may be using a fixed computing device such as a PC or other fixed computing machine, or may be using a portable computing device such as a PDA or cell phone or lap top.

Once a geo-spatial address is defined, either manually or using an interactive graphical interface such as an enhanced version of Google Earth, the next step of the geo-spatial addressing process is for the user (i.e., the caller) to send the real-time message and/or make the real-time communication request to the specified location and/or area. The caller may do this by engaging a user interface in much the same way an instant message or phone call is made today. For example, the user may simply press “send” once he or she has confirmed that his geo-spatial address has been appropriately defined.

Upon a user composing and sending the geo-spatially addressed message and/or communication request, the next step is the routing method in which the sent real-time message and/or real-time communication request is routed to one or more user's who current reside within the defined proximity or area specified by the geo-spatial address. This step is performed by the SM server which keeps track of the location of all active users of the service and determines which of those users, if any, are currently located within the defined proximity or area specified by the geo-spatial address. This is performed using basic coordinate mathematics in which the geo-spatial coordinates for each of the active users is compared with the defined coordinates, proximities, and/or areas specified by the geo-spatial address. If one or more users are identified through this determination step as being within the defined proximity or area specified by the geo-spatial address, unique user identifiers for those one or more users are accessed from a memory store by the SM server. These unique user identifiers may include the unique phone number, unique messaging alias, unique email address, unique URL, and/or other unique user identifier with which the real-time message and/or call may be routed specifically to a portable computing device of the user. The SM server then routes the real-time message and/or real-time communication request by forwarding it to the unique user identifier address. The unique user identifier may be, for example, a unique phone number for the cell phone of an identified user.

In some embodiments, the recipients need not access a real-time message at the time it was sent by a caller, having that message be stored in a digital mailbox for later retrieval. Thus, the message was received in real-time and stored in the mailbox by virtue of the receiving user being at or near the addressed geographic location and/or addressed geographic area at the time when the caller sent the message or initiated the communication.

As mentioned above, embodiments exemplarily described herein provides methods and systems for sending real-time messages and/or for initiating real-time communication from one person to other persons by using geo-spatial addresses as the addressing means. As used herein, a person who sends a real-time message and/or initiates real-time communication with one or more other people is referred to as a “caller” or a “calling user.” As also used herein, a person who receives a real-time message and/or receives a real-time communication is a “recipient” or a “receiving user.” Thus, according to the terms and phrases defined herein, methods and systems are provided to enable a caller to send real-time messages to and/or initiate real-time communication with one or more recipients, not by providing a phone number, email address, user ID, or other personal identifier of the recipients, but instead by specifying a particular geo-spatial location or area such that the message is sent to one or more recipients who are located at or near that geo-spatial location (or area) at the time when the message was sent. As used herein, the coordinates of a particular geographic location and/or a particular geographic area to which a real-time message is sent or with which real-time communication is initiated, is referred to herein as a geo-spatial address.

Enabled by the methods and systems described herein, recipients generally receive real-time messages and/or real-time communication requests by using a local computing device that has access to data indicating the current geo-spatial location of the computing device. Commonly, the computing device used by recipients is a portable computing device enabled with a spatial sensing system such as a GPS transducer that provides the current geo-spatial location data for the user.

As used herein, the phrase “portable computing device” broadly refers to any mobile wireless client device, e.g., a cellphone, pager, a personal digital assistant (PDA, e.g., with GPRS NIC), a mobile computer with a smartphone client, or the like. A typical portable computing device is a wireless access protocol (WAP)-enabled device that is capable of sending and receiving data in a wireless manner using the wireless application protocol. The wireless application protocol (“WAP”) allows users to access information via wireless devices, such as mobile phones, pagers, two-way radios, communicators, and the like. WAP supports wireless networks, including CDPD, CDMA, GSM, PDC, PHS, TDMA, FLEX, ReFLEX, iDEN, TETRA, DECT, DataTAC, and Mobitex, and it operates with many handheld device operating systems, such as PalmOS, EPOC, Windows CE, FLEXOS, OS/9, and JavaOS. Typically, WAP-enabled devices use graphical displays and can access the Internet (or other communication network) on so-called mini- or micro-browsers, which are web browsers with small file sizes that can accommodate the reduced memory constraints of handheld devices and the low-bandwidth constraints of a wireless networks. In a representative embodiment, the mobile device is a cellular telephone that operates over GPRS (General Packet Radio Service), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. In an illustrated embodiment, mobile device users use SMS, which is a text message service that enables short messages (e.g., generally no more than 140-160 characters in length) to be sent and transmitted from a portable computing device. Embodiments disclosed herein are not limited to mobile device users who have WAP-enabled devices or to use of any particular type of wireless network. Such devices and networks are merely illustrative; any wireless data communication technology now known or hereafter developed may be used in connection with the teachings described herein.

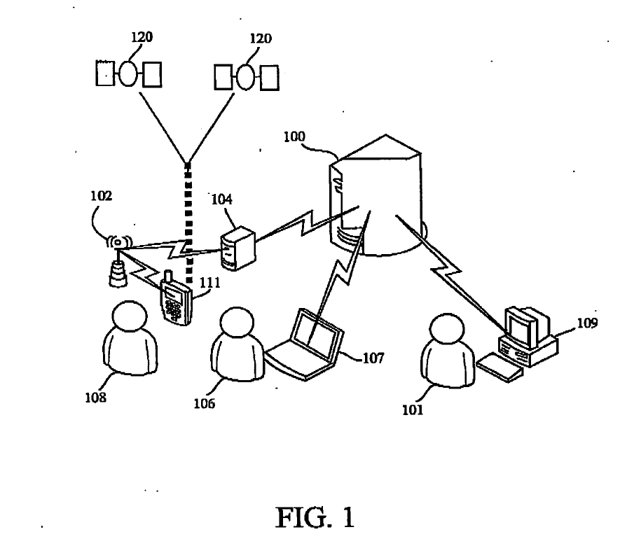

As illustrated in FIG. 1, a real-time location-based messaging system may be implemented as a managed service (e.g., in an ASP model) employing a spatial messaging server 100 (i.e., SM server), which is connected or connectable to one or more networks. For illustrated purposes, the SM server 100 is illustrated as a single machine, but one of ordinary skill will appreciate that this is not a limitation. More generally, the service is provided by an operator using a set of one or more computing-related entities (systems, machines, processes, programs, libraries, functions, or the like) that together facilitate or provide the functionality described herein. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly-routable Internet, a corporate intranet, a private network, or any combination thereof, depending on the desired implementation environment. As illustrated FIG. 1, the SM server 100 is also in communication with a mobile service provider (MSP) 102 through a gateway, such as SMS gateway 104.

As also illustrated in FIG. 1, one or more users 101 may register for the spatial messaging service, typically by using a client machine which may be a personal computer 109. In some embodiments, other users 106 and/or 108 may register for the service using a laptop computer 107 or some other portable computing device such as a cell phone 111. In some embodiments, a formal registration process is required for users to be enabled to act as callers and/or recipients of real-time geo-spatially addressed messages and/or communications. In other embodiments, a formal registration process may not be required and/or may be part of registering for some other service such as cell-phone service. In general, the registration process need only be performed once unless personal parameters change in which case an update registration process is performed. When a desktop computer is used, registration is initiated by an end user opening a Web browser to the operator's Web site registration page (or set of registration pages). When a portable computing device is used, registration may be initiating through a mini-browser or other similar interface. These techniques are merely representative, as any convenient technique (including, without limitation, email, filling out and mailing forms, and the like) may be used. Thus, in the illustrated embodiment, users register with the SM server 100 (or set of servers) either through Internet connections from personal computers, or via remote registration through a mobile device.

Also illustrated in FIG. 1 is a Global Positioning System (GPS) 120 for use in tracking the location of portable computing devices such as device 111. Global Positioning System (GPS) technology provides latitudinal and longitudinal information on the surface of the earth to an accuracy of approximately 100 feet. When combined with accurate location references and error correcting techniques, such as differential GPS, an accuracy of better than 3 feet may be achieved. This information may be obtained using a positioning system receiver and transmitter, as is well known in the art. For purposes of this application, the civilian service provided by Navstar Global Positioning System (GPS) will be discussed with reference to the embodiments described herein. However, other positioning systems are also contemplated for use with embodiments described herein.

In order for GPS to provide location identification information (e.g., a coordinate), the GPS system comprises several satellites each having a clock synchronized with respect to each other. The ground stations communicate with GPS satellites and ensure that the clocks remain synchronized. The ground stations also track the GPS satellites and transmit information so that each satellite knows its position at any given time. The GPS satellites broadcast “time stamped” signals containing the satellites' positions to any GPS receiver that is within the communication path and is tuned to the frequency of the GPS signal. The GPS receiver also includes a time clock. The GPS receiver then compares its time to the synchronized times and the location of the GPS satellites. This comparison is then used in determining an accurate coordinate entry.

Some embodiments may also employ orientation information indicating an orientation of the portable computing device and/or direction of motion of the portable computing device. In such embodiments, additional orientational parameters may be included in a geo-spatial address provided by a caller such that only users who are facing and/or moving in a certain direction (or within a certain range of directions) and/or only users who are positioning their portable computing device (or a portion thereof) at a particular orientation are determined to be recipients of the real-time message or communication associated with that address. In order to gain orientation information, one or more additional sensors may be included within or affixed to the portable computing device. Some sensors can provide tilt information with respect to the gravitational up-down direction. Other sensors can provide orientation information with respect to magnetic north. For example, an accelerometer may be included to provide tilt orientation information about the portable computing device in one or two axes. In some embodiments, a single axis accelerometer is used that senses the pitch angle (tilt away from horizontal) that the portable computing device is pointing. In other embodiments, a 2-axis accelerometer can be used that senses the pitch angle (tilt away from horizontal) that the portable computing device is pointing as well as the roll angle (left-right tilt) that the portable computing device is pointing. A suitable accelerometer is model number ADXL202 manufactured by Analog Devices, Inc. of Norwood Mass. To sense the orientation of the portable computing device with respect to magnetic north, a magnetometer is included. In one embodiment a 3-axis magnetometer model number HMC1023 manufactured by Honeywell SSEC of Plymouth, Minn is included. This sensor produces x, y and z axis signals. In addition, some embodiments may include a gyroscope such as a 1-axis piezoelectric gyroscope model number ENC-03 manufactured by Murata Manufacturing Co., Ltd. of Kyoto, Japan to further sense changes in orientation of the portable computing device. All of the orientation sensor may all be housed within the casing of the portable computing device and be connected electronically to the microprocessor of the portable computing device such that the microprocessor can access sensor readings and perform computations based upon and/or contingent upon the sensor readings.

For embodiments that employ user facing direction information, the orientation sensor may alternately be incorporated into a unit that is maintained at a fixed orientation within respect to a portion of the user's body. For example, the orientation sensor may be a magnetometer that is affixed to or incorporated within the user's belt, shoes, clothing, and/or headset worn by the user so that the orientation value reflects a known orientation of the user's body with respect to the physical world. In this way, the orientation sensor data may be used to determine which way the user is currently facing regardless of how the portable computing device may be held by the user. In such embodiments, the unit that contains the orientation sensor may be linked by wireless communication to the portable computing device described herein. For example, a Bluetooth link may be provided between the portable computing device described herein and the orientation sensor that provides user facing information. For example, a magnetometer sensor may be incorporated into a shoe or belt or headset of the user and may be configured to transmit user orientation data by Bluetooth link to the portable computing device described herein.

In order to gain direction of motion information, a time-history of spatial location information may be collected, stored, and processed. For example, a current GPS location and a previous GPS location may be collected and stored by a portable computing device. Using basic vector math upon the two stored coordinates a direction of motion of the user of the portable computing device may be determined. In addition to determining a direction of motion using basic vector math upon the two stored coordinates, a speed of motion of the user may be determined. In some embodiments, a time history of stored coordinates may include more than two coordinate values to get more accurate direction of motion and/or speed of motion values.

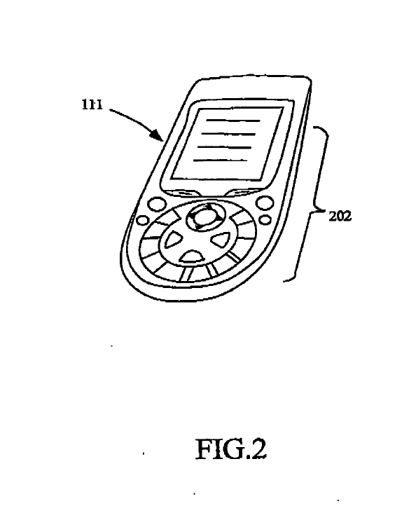

FIG. 2 illustrates an exemplary portable computing device 111 configured with appropriate hardware and software to support the embodiments disclosed herein. The portable computing device 111 comprises a portable computer with communication capabilities or a similar processor driven portable device including but not limited to a cell phone, personal digital assistant (PDA), portable media player, or processor enabled wristwatch. The portable computer or other processor driven portable device also includes a wireless connection to a computational network such as the Internet. To determine the current spatial position of each portable computing device, each portable computing device includes GPS sensor or other positional sensing system. To optionally determine the spatial orientation of each portable computing device, additional specialized sensors for orientation sensing such as accelerometer sensors, tilt sensors, magnetometer sensors may be included. In some embodiments, the portable computing device includes a radio frequency (RF) transceiver for accessing a remote network. It should be noted that other bidirectional communication links can be used other than or in addition to RF. The portable computing device generally includes a casing, a microcontroller, a wireless communication link such as the aforementioned RF transceiver, and position and orientation sensors which are connected to the microcontroller, and a power supply (e.g., batteries) for powering these electronic components. The portable computing device may also include user input components such as a user activated switches or buttons or levers or knobs and use output components such as touch screens or microphones or speakers or LCD displays or lights or graphical displays. These input and output components, all of which are connected to the microcontroller, are employed for the purpose providing information display to users and/or for allowing the user to provide input to the system. These input and output components are collectively referred to as the user interface (UI) 202 of the portable computing device. The portable computing device 111 also includes hardware and/or software for enabling a user to send and receive communications with other users such as a microphone and speaker for voice communication and/or a keyboard and screen for text communication. The portable computing device 111 also contains spatial messaging client circuitry (i.e., SM client circuitry) adapted to enable a user to receive real-time geospatially addressed messages and/or communications. Such SM client circuitry is also equivalently referred to herein as an “SM client application”.

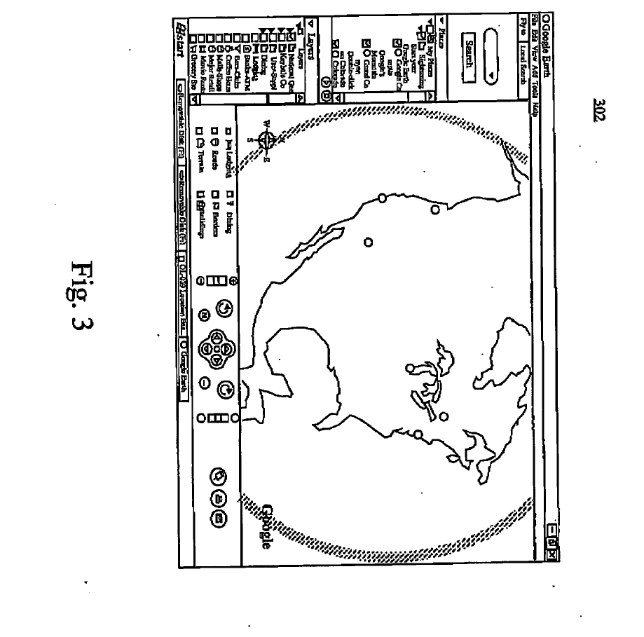

In some embodiments, the SM client application is also adapted to enable a user to send real-time geospatially addressed messages and/or communications. In such embodiments the SM client application also includes user interface routines for enabling a user to enter or otherwise specify a geospatial address. Entering a geo-spatial address includes providing and/or indicating and/or otherwise specifying a geo-spatial location and/or area. The geo-spatial address will include at least one set of coordinates identifying the geo-spatial location and/or area. The geo-spatial address may also include a proximity value (or values) that defines an addressed area with respect to the provided geo-spatial coordinates. The geo-spatial address may include a plurality of geo-spatial coordinates that define an addressed area in the physical world. In some embodiments, a default proximity value is used such that a user need only identify a single geo-spatial coordinate with the understanding that a default proximity will be used to create an area about that geo-spatial coordinate. In some embodiments, specialized user interface techniques are used to enable a user to provide, enter, select, or otherwise indicate a geo-spatial location and/or area to be used as a geo-spatial address for a real-time message and/or communication. Some of such embodiments employ a graphical user interface through which a user can visually navigate a geo-spatial map or globe and by zooming in and using graphical selection tools, may quickly and easily specify a geo-spatial address for a real-time message. In some embodiments, an existing geo-spatial information navigation interface such as Google Earth may be used as a front-end to support such features. An exemplary user interface provided to users for facilitating the specifying of geo-spatial addresses using a graphical navigation tool such as Google Earth will be described in more detail with respect to FIGS. 3-7 below.

Referring back to FIG. 1, a plurality of portable computing devices 111 may be employed, wherein each portable computing device is equipped with a positioning system such as a GPS transducer interfaced with a Navistar Global Positioning System 120 and each having wireless access to SM server 100 running an SM application. Communication between each portable computing device 111 and the SM server 100 is generally enabled through a wireless transceiver connected to and/or integrated within each of the plurality of portable computing devices. The GPS transducer and/or other position and/or orientation transducers associated with each portable computing device are operative to generate a coordinate that relates to the then current position (and optionally orientation and/or direction of motion and/or speed of motion) of that portable computing device, the coordinate entry and/or a representation thereof is communicated over the wireless communication link to the SM server running the SM application along with identifying information that indicates from which portable computing device (and/or which user) the coordinate entry was received. In this way, the SM server 100 running the SM application receives coordinate information representing the then current location (and optionally orientation and/or direction of motion and/or speed of motion) of each of a plurality of users 108 using a portable computing device 111 supporting the aforementioned SM client application.

In some embodiments each portable computing device 111 has a unique ID associated with it such that when coordinate data is transmitted to the SM server 100 it is sent along with the unique ID such that the SM server 100 can identify by means of the unique ID which portable computing device among a plurality of portable computing devices the coordinate data is associated with. In some embodiments each user 108 of a portable computing device 111 has a unique ID associated personally with that user such that when coordinate data is transmitted to the SM server 100 it is sent along with the unique personal ID such that the SM server can track by means of the unique personal ID which user among the plurality of users who are members of the SM service the coordinate data is associated with.

The SM server 100, in combination with one or more other computing devices 107, 109, and 111, provides a geo-spatial addressing system in which a user of a computing device 107, 109, or 111 can send a real-time message or initiate real-time communication to one or more other users by addressing the real-time message and/or communication request to a particular spatial location and/or spatial area in the physical world, the one or more other users using appropriately enabled portable computing devices and residing then currently at a location that is at or near the addressed spatial location and/or spatial area. As defined herein, the phrase “at or near” means within a certain defined proximity of the specified geo-spatial location and/or within the area defined by the geo-spatial address. For example, a geo-spatial address may be represented as a GPS coordinate location in the physical world and a proximity distance specified in feet away from that GPS coordinate location. A geo-spatial address consistent with such a representation might be defined as a latitude/longitude pair equal to (37°25′38.08″ N/122°4′49.98″ W) and a proximity distance of 30 feet. This geo-spatial address is used by the SM server 100 to route an associated real-time message and/or real-time communication request to all enabled and active users who currently reside within 30 feet of the specified coordinates. As used herein, the phrase “users who currently reside” refers to users who are within the specified geo-spatial region approximately at the time when the real-time message and/or real-time communication request was sent.

The geo-spatial addressing method involved a number of steps performed by the SM server 100 in combination with a SM client application supported by one or more other computing devices 107, 109, 111. One step is referred to herein as a background tracking step because it is performed repeatedly as a running background function. The background tracking step involves the SM server 100 maintaining a database that tracks the location of a plurality of users 108 of computing devices (e.g., portable computing devices 111). In the background tracking step, each enabled and active computing device detects a current spatial positional coordinate from the spatial location sensor on board (or connected to) that portable computing device and reports a representation of the current spatial coordinate to the SM server 100. This step is repeatedly performed at a rapid rate such that the SM server 100 receives repeatedly updated and substantially current data about the spatial location of the plurality of computing devices.

The location information received by the SM server 100 from each portable computing device 111 includes spatial coordinates such as GPS coordinates of high resolution and accuracy and is stored in a tracking database by the SM server 100. The tracking database may also store a history of the location information for each of the plurality of portable computing devices. The tracking database may also include predictive location information for some or all of the plurality of portable computing devices, the predictive location information representing an anticipated location coordinate for a portable computing device as determined from current and/or historical location information and/or from velocity information for a portable computing device. Although there are many way it may be maintained, the tracking database includes substantially current information that represents the location of each of a plurality of portable computing devices based substantially upon positional data received by the SM server 100 over a communication link.

It should be noted that there are a variety of techniques for reducing the amount of information that must be transmitted from each of the plurality of portable computing devices to the SM server 100 while still allowing the SM server 100 to maintain relatively up-to-date spatial location information for each of the portable computing devices. In one such method, each portable computing device only reports its current positional coordinates to the SM server 100 if it is determined that the detected positional coordinates for that portable computing device has changed by more than some minimum threshold value since the last positional coordinate update was sent to the SM server 100. For example, software running on a portable computing device 111 detects current spatial positional coordinate from the spatial location sensor on board (or connected to) the portable computing device and reports a representation of the current spatial coordinate to the SM server 100 at a first moment in time. The software running on the portable computing device 111 stores a copy of this spatial coordinate in memory while repeatedly detecting updated spatial positional coordinates from the spatial location sensor on board (or connected to) the portable computing device. The updated spatial positional coordinates are repeatedly compared with the stored spatial coordinates in memory to determine if the portable computing device has moved by more than some minimum threshold distance. In some embodiments, the minimum threshold distance is 6 feet. If the user is stationary and/or has not moved more than 6 feet from the time the last positional coordinate update was sent to the SM server 100, no additional positional data is sent to the SM server 100. If, on the other hand, it is determined that the user's current position has changed by more than 6 feet from the last coordinate update sent to the SM server 100, a new updated position coordinate is sent from the portable computing device to the SM server 100. In this way, positional data is only sent from a portable computing device 111 to the SM server 100 when enough position change has occurred that the SM server 100 needs to update its documented location of that user/portable computing device. Thus, the rate that each portable computing device reports its current positional coordinates to the SM server 100 is variable based upon the speed and/or amount of spatial motion being imparted upon the portable computing device its user. In this way, communication bandwidth burden on the SM server 100 is reduced.

The remaining steps of the geo-spatial addressing method are performed each time a user sends a real-time message and/or a real-time communication request using a geo-spatial address. These steps are referred to herein as geo-spatial addressing steps. In the first geo-spatial addressing step, a user (i.e., a “caller”) addresses a real-time message and/or addresses a real-time communication request using a geo-spatial address. This may be performed by the user entering a spatial coordinate, such as a GPS coordinate, into an address line of a real-time messaging user interface and/or a real-time communication request user interface (collectively referred to herein as a “real-time communication interface”). For example, a GPS coordinate could be entered in the same way a user manually enters an email address, an instant messaging alias, a phone number, other common address used by current messaging and communication systems. In addition to the GPS coordinate, the user may enter a proximity value defining the proximity to the GPS coordinate for which users will be targeted. Alternatively, the user may enter spatial area or volume values that define a bounded area or volume with respect to the GPS coordinate for which users will be targeted with the addressed message and/or communication request. Alternatively, the user may enter a set of GPS coordinates that define the boundaries of a spatial area within which users will be targeted with the message and/or communication request. In addition, the user may enter altitude values to further specify the geo-spatial location and/or area for addressing.

Because it is generally more cumbersome to enter a GPS coordinate than entering a phone number or email address, many user interface methods and systems may be implemented to facilitate a user's efforts in defining a particular geo-spatial location and/or area to be used as the address for a message or communication request. For example, one user interface method may provide callers with an interactive graphical environment for searching and finding desired geo-spatial locations and/or areas within the physical world by viewing visual representation of the physical world. Once a user has found a desired geo-spatial location and/or area within the physical world by navigating the visual representation of the physical world, the user is then provided with the ability to select a location and/or area within the graphical environment for use as a geo-spatial address that will be associated with a real-time message or communication. The selection process may employ a graphical user interface in which a user can select, using a cursor and commonly known graphical selection processes, a particular location and/or area and/or region within the visual representation of the physical world that is desired to be used as a geo-spatial address.

In one embodiment, an existing software tool such as Google Earth is used as the graphical environment for navigating a visual representation of the physical world such that geo-spatial coordinates can be viewed and identified. Referring to FIG. 3, an exemplary navigation screen 302 provided by Google Earth is shown. As shown, a user running the Google Earth application is provided with a visual representation of the physical world. The user may navigate this visual representation of the world by panning left, right, up, and down upon a spatially rotating globe as well as by zooming in and out upon specific areas of the earth. For example, by zooming and panning in appropriate directions a user can find a very specific geo-spatial location on the planet earth. Google Earth-provided satellite photography and/or aerial photography in a spatially mapped format such that the visual representation of the locations presented by the Google Earth navigation interface provides for a photo-realistic representation of the physical places explored. Often, the photographs are enhanced with graphical overlays including additional reference information. In this way, a user can navigate, zoom, explore and quickly find particular desired locations. In some cases, a user can enter in a location by name and have the software assist the user in zooming and panning to the desired location.

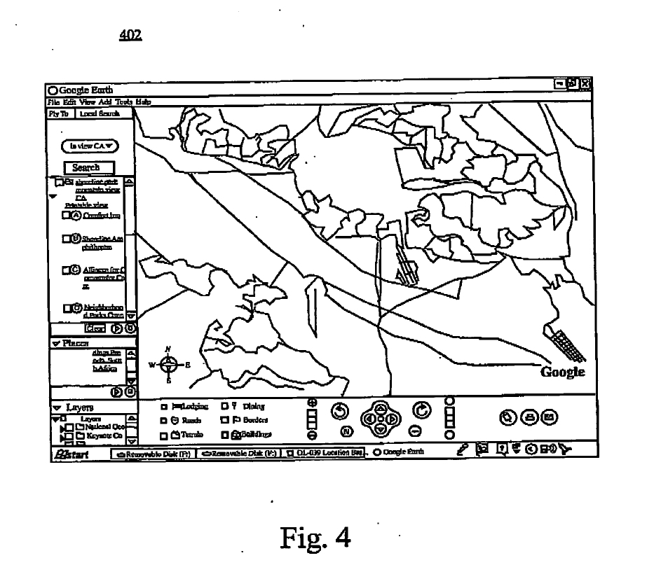

FIG. 4 illustrates an updated view 402 of the Google Earth interface such that user has navigated to a view showing a portion of the San Francisco Bay Area. This may be a step in the process for a user who, for example, wanted to send a real-time message and/or communication to a geo-spatial address in the San Francisco Bay Area. The user would then continue to navigate using the interface tools of Google Earth to zoom in and pan appropriately to find the specific location he or she chooses to address geo-spatially for messaging purposes.

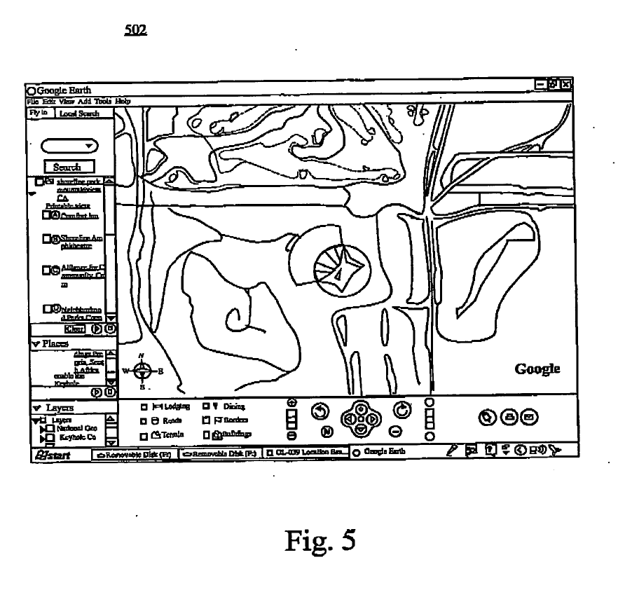

FIG. 5 illustrates a further updated view 502 of the Google Earth interface such that the user has navigated further towards their desired location. The image now shows a more specific portion of the San Francisco Bay Area, including a specific portion of the city of Mountain View Calif. As shown near the center of the image is a specific location within the city of Mountain View called the Shoreline Amphitheater which is the white tent-like structure at the center of the screen. Also shown is a portion of the Shoreline Golf Course in the upper central region of the geo-spatial display.

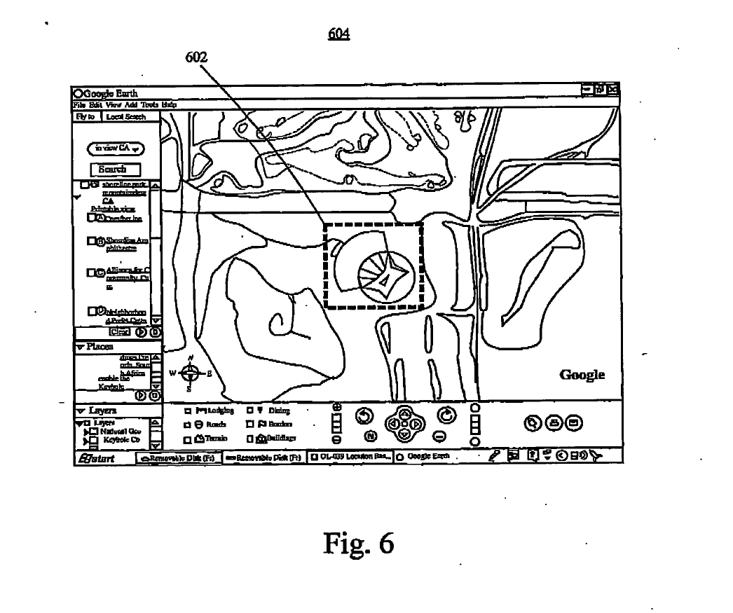

Once the user has zoomed and panned to the desired visual representation of the physical world, the user may then use the user-interface functions to specify a particular location and/or area to be used as a geo-spatial address for real-time messaging and/or communication. This may be done using a mouse or other cursor-control interface. In one such embodiment, the user controls the cursor to draw a box and/or other set of boundary lines around a desired area shown on the visual display. For example, the user may put a box around the portion of the Shoreline Amphitheater that he or she wants to use as a geo-spatial address. FIG. 6 shows what the result of such a user-interface function may look like.

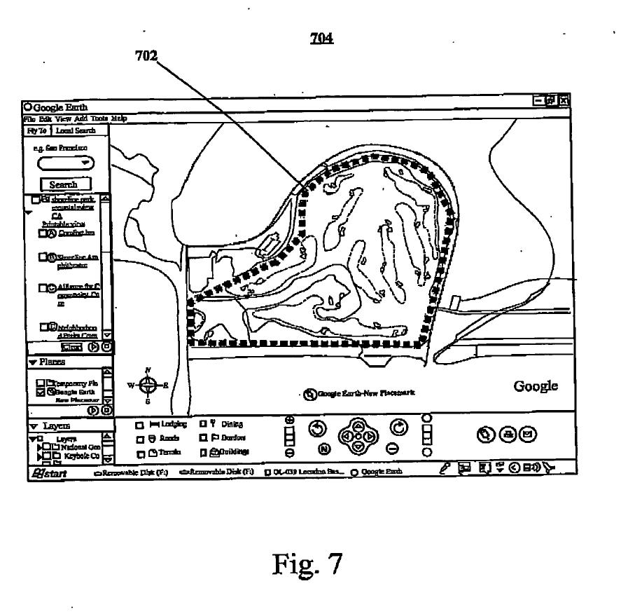

As shown in FIG. 6, the user has drawn a rectangular box 602 around an area of the geo-spatial visual display 604 as the means of selecting and/or defining the area to be used as a geo-spatial address. In this case, the area defined by box 602 specifically defines a spatial area around the Shoreline Amphitheater. When complete, the user may press a button, select a menu entry, or otherwise specify that the drawn box 602 should be used to define the geo-spatial address. The software then produces a geo-spatial address that represents the defined region. Since the particularly illustrated region is a rectangle, the geo-spatial address may be defined as a set of GPS coordinates that represent the corners of the rectangular box 602 drawn by the user as referenced to the real physical world. For example, the GPS coordinates that correspond with the drawn location of each corner of the rectangular box may be selected and used in the automatic generation of a geospatial address. Alternately, a single GPS coordinate may be used along with a geometric representation of the rectangular shape to define the specified region as a geo-spatial address. While only a rectangular box 602 is shown, it will be appreciated that a user can select and/or define the area to be used as a geo-spatial address by drawing circular regions, elliptical regions, and/or irregularly shaped regions may be defined using known cursor control methods. FIG. 7 illustrates an example of an irregularly shaped region 702 defined by a user wielding a mouse, the irregularly shaped region 702 defining an area for geo-spatial messaging that correspond roughly with the spatial boundaries of a golf course in the real physical world.

The enhanced user interface methods may be enabled in existing software tools such as Google Earth either through direct coding or through API enabled plug-ins. In this way, the geo-spatial addressing features disclosed herein are supported. In such embodiments, a user may interactively explore a graphical representation of the physical world witin a tool such as Google Earth, navigating coordinates by viewing graphical and photographic representations of the real physical world. When a user finds a desired location in Google Earth and views it visually upon his or her user interface, the user may use the enhanced features disclosed herein to select a geographic coordinate location for use as a geo-spatial messaging address. The selected coordinates are then automatically inserted into a selected real-time message and/or communication request. Even more powerful are the interactive geographic-location features in which a user may graphically define an area upon the visually displayed representation of the physical world presented by Google Earth using a mouse, cursor, and/or other common user interface methods and systems. By defining such an area upon the visually displayed representation of the physical world and selecting the provided user interface options, a caller may define a geographic area in the physical world quickly and easily that is automatically converted into the format of a geo-spatial address. This geo-spatial address is then automatically inserted into a selected real-time message and/or communication request. The authoring and addressing step of the messaging process need not be performed from a portable computing device. The caller may be using a fixed computing device such as a PC or other fixed computing machine, or may be using a portable computing device such as a PDA or cell phone or lap top.

Once a geo-spatial address is defined, either manually or using an interactive graphical interface such as an enhanced version of Google Earth, the next step of the geo-spatial addressing process is for the user (i.e., the caller) to send the real-time message and/or make the real-time communication request to the specified location and/or area. The caller does this by engaging a user interface in much the same way an instant message or phone call is made today. For example, the user may simply press “send” once he or she has confirmed that his geo-spatial address has been appropriately defined. In one embodiment, a messaging tool is provided such that a user may draft a real time message using word-processor like features and functions, select a geo-spatial address by linking to a tool such as the enhanced version of Google Earth described above, and then send a message by clicking on an appropriate user interface function such as a “send” button.

Once a user has composed and sent the geo-spatially addressed real-time message and/or real-time communication request, the next step is the routing method in which the real-time message and/or real-time communication request is routed to one or more users who current reside within the defined proximity or area specified by the geo-spatial address. This step is performed by the SM server 100 which keeps track of the location of all active users of the service and determines which of those users, if any, are currently located within the defined proximity or area specified by the geo-spatial address. This is performed using basic coordinate mathematics in which the geo-spatial coordinates for each of the active users is compared with the defined coordinates, proximities, and/or areas specified by the geo-spatial address. If one or more users are identified through this determination step as being within the defined proximity or area specified by the geo-spatial address, unique user identifiers for those one or more users are accessed from a memory store by the SM server 100. These unique user identifiers may include the unique phone number, unique messaging alias, unique email address, unique URL, and/or other unique user identifier with which the real-time message and/or call may be routed specifically to a computing device of the user. These unique user identifiers may be provided by the user during a registration step described earlier and then stored within a user address database maintained by the SM server 100.

Accessing the store of unique user identifiers, the SM server 100 then routes the real-time message and/or real-time communication request to the appropriately located users by forwarding it to the unique user identifier address. For example, a real-time text message is sent by a caller to a specific geo-spatial location. Upon receiving a representation of the geo-spatially addressed text message, the SM server 100 determines that there are two users within the defined proximity or area specified by this particular geo-spatial address. The SM server 100 then accesses one or more unique user identifiers for each of the two individuals from memory. These unique user identifiers may be, for example, a unique phone number for the cell phone of each of the individuals. The text message is then routed by the SM server 100 to each of the two unique phone numbers. In this way, the message that was addressed geo-spatially by a caller was routed specifically to those active users who were within the specified geographic location and/or area.

In some embodiments, the recipients need not access a real-time message at the time it was sent by a caller, having that message be stored in a digital mailbox for later retrieval. Thus, the message was received in real-time and stored in the mailbox by virtue of the receiving user being at or near the addressed geographic location and/or addressed geographic area at the time when the caller sent the message or initiated the communication.

According to numerous embodiments, a user interface functionality may be provided upon the computing devices of users to enable users to configure their device to be active or inactive. When the portable computing device is active, it is functional to provide real-time location information to the SM server 100 such that the SM server 100 can track the user's location as described herein and as required by the messaging features. When active the portable computing device may be messaged and/or called with real-time geo-spatially addressed communications from other users. When the portable computing device is configured in an inactive mode, the device does not provide real-time location information to the SM server 100 and/or will not receive real-time geo-spatially addressed communications from other users. In this way, a user may select whether or not they desire to be a recipient of real-time geo-spatially addressed communications from other users.

In general there are varieties of ways in which real-time spatial location information may be communicated from the portable computing devices to the SM server 100 as well as a variety of ways in which real-time communications may be routed by the SM server 100 to portable computing devices. For example, messages including location information from portable computing devices may be sent to the server's pre-assigned short code (e.g., a five digit mobile device code associated with the service). The message may be delivered to an SMS gateway by a mobile carrier; the gateway, in turn, relays the message to the server. The message includes unique identification information and locative values that are parsed by the server. The server recognizes the device's unique mobile number or other ID, from which the identity of the user is determined (based on the registration). The server then updates a database in which the tracking location is stored for each user (or device). Similarly message and/or communication request may be routed in the reverse direction through an SMS gateway by a mobile carrier as well.

It should be noted that a unique benefit is that a user may send real-time messages and/or initiate real-time communication with other users through a means in which the identity of the caller and/or the recipients may remain anonymous to the other parties involved. This is because a caller need not know the unique identity or possess any unique user identifier for a recipient in order to send a real-time message to and/or initiate real-time communication with that recipient. Instead, the caller need only to specify a geographic location at or near the recipient's then current location.

It should also be noted that another unique benefit is the ability for a caller to communicate to a plurality of recipients in real-time by specifying a unique location for the communication to be sent to in real-time. For example, a caller may wish to inform a plurality of individuals who happen to be currently residing on a particular stretch of beach-front property that a pod of whales was just spotted in the north-west direction just off the coast so that any interest people at that location can look in the proper direction and see the whales at the present time. Embodiments exemplarily described herein allow such a message to be sent in real time from one user to a plurality of other users, with addressing specificity to the relevant geographic area without that user needed any knowledge of who the individual recipients of his or her message are. All that the caller needs to know is that his real-time message will be sent to those individuals with active portable computing devices who are in the defined location at the current time.

In addition, the spatial messaging server 100 described above may be configured to return data to the device of the caller, the data indicating the status of the geospatially addressed message sent. In one exemplary embodiment, the spatial messaging server 100 returns data to the user indicating the number of users whom were messaged based upon their current location with respect to the geospatial addressing information and/or other qualifier tags. For example, if a user sent a geospatial addressing message to the rectangular area 601 as shown in FIG. 6, and as a result of the message request the geospatial server sent the target message to 36 unique users who were currently located within the defined area, the geospatial server may be configured to return a message to the caller indicating that 36 users were successfully messaged in response to the geospatial messaging request. Alternately, if the user sent a geospatial message to an address defining area 702 in FIG. 7 and associated two demographic qualifier tags such that the messages were only to be delivered to female users between 25 and 35 years old, it may be the case that no currently active users of the messaging service were currently residing within area 702 who met the demographic qualifier tag constraints. In such an event, the spatial messaging server may be configured to report back to the caller that no users were successfully messaged as a result of the geospatial messaging request.

While the above describes a particular order of operations performed by certain embodiments exemplarily described herein, it should be understood that such order is exemplary, as alternative embodiments may perform the operations in a different order, combine certain operations, overlap certain operations, or the like. References in the specification to a given embodiment indicates that the embodiment described may include a particular feature, structure, or characteristic, but every embodiment may not necessarily include the particular feature, structure, or characteristic.

While embodiments exemplarily described herein have been described in the context of a method or process, as noted above, the exemplarily described embodiments also relate to apparatus or systems for performing the operations herein. The systems may be specially constructed for the required purposes, or they may comprise a general-purpose computer (or multiple computers) selectively activated or reconfigured by a computer program stored in the computer. Such a computer program may be stored in a computer readable storage medium, such as, but is not limited to, any type of disk including an optical disk, a CD-ROM, and a magnetic-optical disk, a read-only memory (ROM), a random access memory (RAM), a magnetic or optical card, or any type of media suitable for storing electronic instructions, and each coupled to a computer system bus.

While embodiments have been exemplarily described herein by means of specific examples and applications thereof, numerous modifications and variations could be made thereto by those skilled in the art without departing from the scope of the invention set forth in the claims.

What is claimed is:

1. A location-based communication method, comprising:
receiving location information, the location information identifying a current geospatial location of a mobile computing device of each of a plurality of users;
receiving a geo-spatial address from a device of a calling user;
determining whether the current geospatial location of the mobile computing device satisfies a predetermined relationship with the geo-spatial address;
identifying a unique identifier associated with the mobile computing device having a current geospatial location determined to satisfy the predetermined relationship with the geo-spatial address; and
routing a real-time communication from the device of the caller to the mobile computing device having a current spatial location determined to satisfy the predetermined relationship with the geo-spatial address via the identified unique identifier.

2. The location-based communication method of claim 1, wherein the device of the caller comprises at least one of a stationary computing device and a portable computing device.

3. The location-based communication method of claim 1, wherein the geo-spatial address comprises at least one of a spatial location and a spatial area in the physical world.

4. The location-based communication method of claim 1, wherein the predetermined relationship is a requirement that the current spatial location is within a certain proximity of the geo-spatial address.

5. The location-based communication method of claim 1, wherein the predetermined relationship is a requirement that the current spatial location is within a defined area or defined volume associated with the geo-spatial address.

6. The location-based communication method of claim 1, wherein the unique identifier comprises at least one of a phone number, an email address, a messaging alias, a device address, and a URL.

7. The location-based communication method of claim 1, wherein the real-time communication comprises at least one of a real-time message and a real-time communication request.

8. The location-based communication method of claim 1, wherein the real-time communication from the device of the caller is routed substantially simultaneously to a plurality of mobile computing devices, each of the plurality of mobile computing devices having a current spatial location determined to satisfy the predetermined relationship with the geo-spatial address.

9. The location-based communication method of claim 1, further comprising limiting the routing of the real-time communication from the caller only to mobile computing devices of users who satisfy certain demographic criteria based upon a demographic qualifier, the demographic qualifier being definable by the caller.

10. The location-based communication method of claim 9, wherein the demographic criteria comprises at least one of a defined gender, a defined age range, a defined grade level, a defined organizational affiliation, a defined school affiliation, a defined political affiliation, and a defined professional affiliation.

11. A location-based communication system, comprising:
a server containing circuitry adapted to:
receive location information, the location information identifying a current geospatial location of a mobile computing device of each of a plurality of users;
receive a geo-spatial address from a device of a calling user;
determine whether the current geospatial location of the mobile computing device satisfies a predetermined relationship with the geo-spatial address;
identify a unique identifier associated with the mobile computing device having a current geospatial location determined to satisfy the predetermined relationship with the geo-spatial address; and
route a real-time communication from the device caller to the mobile computing device having a current spatial location determined to satisfy the predetermined relationship with the geo-spatial address via the identified unique identifier.

12. The location-based communication system of claim 11, wherein the device of the caller comprises at least one of a stationary computing device and a portable computing device.

13. The location-based communication system of claim 11, wherein the geo-spatial address comprises at least one of a spatial location and a spatial area in the physical world.

14. The location-based communication system of claim 11, wherein the predetermined relationship is a requirement that the current spatial location is within a certain proximity of the geo-spatial address.

15. The location-based communication system of claim 11, wherein the predetermined relationship is a requirement that the current spatial location is within a defined area or defined volume associated with the geo-spatial address.

16. The location-based communication system of claim 11, wherein the unique identifier comprises at least one of a phone number, an email address, a messaging alias, a device address, and a URL.

17. The location-based communication system of claim 11, wherein the real-time communication comprises at least one of a real-time message and a real-time communication request.

18. A location-based communication method, comprising:
generating a geo-spatial address;
addressing a real-time communication with the geo-spatial address; and
transmitting the real-time communication addressed with the geo-spatial address to a server, wherein the server is adapted to route the real-time communication to a mobile computing device that has a current geospatial location satisfying a predetermined relationship with the geo-spatial address.

19. The location-based communication method of claim 18, wherein generating the geo-spatial address comprises:
receiving a spatial coordinate via a user interface; and
generating the geo-spatial address based upon the received spatial coordinate.

20. The location-based communication method of claim 19, further comprising:
graphically presenting a plurality of spatial coordinates to a user via the user interface, the plurality of spatial coordinates being selectable by a user via the user interface, wherein
receiving the spatial coordinate comprises receiving spatial coordinate that has been selected by the user.

21. The location-based communication method of claim 20, wherein graphically presenting the plurality of spatial coordinates comprises graphically presenting overhead geospatial mapping imagery to the user.

22. The location-based communication method of claim 21, wherein the overhead geospatial mapping imagery comprises at least one of satellite imagery and aerial photography.

23. The location-based communication method of claim 21, further comprising enabling the user to graphically outline a graphical area upon the geospatial mapping imagery as a means of selecting a desired geospatial address.

24. The location-based communication method of claim 18, wherein the predetermined relationship is a requirement that the current spatial location is within a certain proximity of the geo-spatial address.

25. The location-based communication method of claim 18, wherein the predetermined relationship is a requirement that the current spatial location is within a defined area or defined volume associated with the geo-spatial address.

26. The location-based communication method of claim 18, wherein the real-time communication comprises at least one of a real-time message and a real-time communication request.

27. A location-based communication system, comprising:
a device containing circuitry adapted to:
generate a geo-spatial address; and
address a real-time communication with the geo-spatial address; and
a transmitter adapted to transmit the real-time communication to a server, wherein the server is adapted to route the real-time communication to a plurality of mobile computing devices that have a current geospatial location satisfying a predetermined relationship with the geo-spatial address.

28. The location-based communication system of claim 27, wherein the computing device further comprises:
a user interface adapted to:
receive a spatial coordinate; and
generate the geo-spatial address based upon the received spatial coordinate.

29. The location-based communication system of claim 28, wherein the user interface is further adapted to:
graphically present a plurality of spatial coordinates to a user, the plurality of spatial coordinates being selectable by a user via the user interface, wherein
generate the geo-spatial address based upon the spatial coordinate that has been selected by the user.

30. The location-based communication system of claim 29, wherein the user interface is further adapted to graphically present the plurality of spatial coordinates by graphically presenting overhead geospatial mapping imagery to the user.

31. The location-based communication system of claim 30, wherein the overhead geospatial mapping imagery comprises at least one of satellite imagery and aerial photography.

32. The location-based communication system of claim 30, wherein the user interface enables the user to graphically outline a graphical area upon the geospatial mapping imagery as a means of selecting a desired geospatial address.

33. The location-based communication system of claim 27, wherein the predetermined relationship is a requirement that the current spatial location is within a certain proximity of the geo-spatial address.

34. The location-based communication system of claim 27, wherein the predetermined relationship is a requirement that the current spatial location is within a defined area or defined volume associated with the geo-spatial address.

35. The location-based communication system of claim 27, wherein the real-time communication comprises at least one of a real-time message and a real-time communication request.

36. The location-based communication system of claim 11, wherein the real-time communication from the device of the caller is routed substantially simultaneously to a plurality of mobile computing devices, each of the plurality of mobile computing devices having a current spatial location determined to satisfy the predetermined relationship with the geo-spatial address.

37. The location-based communication system of claim 11, wherein the circuitry is adapted to limit the routing of the real-time communication from the caller only to mobile computing devices of users who satisfy certain demographic criteria based upon a demographic qualifier, the demographic qualifier being definable by the caller.

38. The location-based communication system of claim 37, wherein the demographic criteria comprises at least one of a defined gender, a defined age range, a defined grade level, a defined organizational affiliation, a defined school affiliation, a defined political affiliation, and a defined professional affiliation.

39. The location-based communication system of claim 37, wherein the demographic criteria comprises at least one of a sports team, a musical group, and a political candidate that the addressed users are documented as being a fan of.
